(19) United States
(12) Patent Application Publication
(10) Pub. No.: US 2007/0203708 A1
(43) Pub. Date: Aug. 30, 2007

(54) System and method for providing transcription services using a speech server in an interactive voice response system

(75) Inventors: Michael J. Polcyn, Allen, TX (US); Ellis K. Cave, Plano, TX (US); Kenneth E. Waln, Los Altos, CA (US); Bogdan Blaszczak, Coppell, TX (US)

Correspondence Address: FULBRIGHT & JAWORSKI L.L.P, 2200 ROSS AVENUE, SUITE 2800, DALLAS, TX, 75201-2784, US

(73) Assignee: InterVoice Limited Partnership, Las Vegas, NV (US)

(21) Appl. No.: 11/364,353

(22) Filed: Feb. 28, 2006

(51) Int. Cl. G10L 21/00

(52) U.S. Cl. 704/270.1

(57) ABSTRACT

The present invention is directed to a system and method in which an interface (proxy) is positioned between a browser and a speech server such that the proxy, while transparent to both the browser and the speech server, collects and stores data, including utterances and other media obtained from a user, such that the media data can be retrieved in a uniform manner for subsequent manipulation, such as, for example, transcription or presentation (or preservation) of a tangible format of the media as a function of a transaction session with the user. The proxy is a passive monitoring device positioned between the functioning components of a system such that the proxy looks to the browser as a speech server and looks to the speech server as a browser.

### CROSS-REFERENCE TO RELATED APPLICATIONS

The present application is related to copending and commonly assigned U.S. patent application Ser. No. ______ [Attorney Docket No. 47524-P137US-10501428] entitled “SYSTEM AND METHOD FOR MANAGING FILES ON A FILE SERVER USING EMBEDDED METADATA AND A SEARCH ENGINE,” U.S. patent application Ser. No. ______ [Attorney Docket No. 47524-P138US-10501429] entitled “SYSTEM AND METHOD FOR RETRIEVING FILES FROM A FILE SERVER USING FILE ATTRIBUTES,” and U.S. patent application Ser. No. ______ [Attorney Docket No. 47524-P139US-10503962] entitled “SYSTEMS AND METHODS FOR DEFINING AND INSERTING METADATA ATTRIBUTES IN FILES,” filed Feb. 24, 2006, the disclosures of which are hereby incorporated herein by reference. Also incorporated by reference herein is concurrently filed and commonly assigned U.S. patent application Ser. No. ______ [Attorney Docket No. 47524-P144US-1060217] entitled “SYSTEM AND METHOD FOR CENTRALIZING THE COLLECTION OF LOGGING DATA IN A COMMUNICATION SYSTEM”.

### TECHNICAL FIELD

This disclosure relates to the field of Interactive Voice Response (IVR) systems and more particularly to such systems wherein media data is collected in a central database from a plurality of individual transaction sessions such that translation of the media data from one form to another can be accomplished.

### BACKGROUND OF THE INVENTION

Current Interactive Voice Response (IVR) systems include several disparate components, such as application servers, browsers, speech servers, as well as other elements, such as databases and telephony subsystems. All of these components can generate event information that needs to be logged during the course of application execution. The logged information is then used, for example, to tune the system for better performance, or inform the administrator about system operation.

In this context, logging refers to the recording and storage of event records and the various data that is associated with these events. So in the context of an IVR system, the events that occur in a portion of an interactive application may include the playing of a prompt, the capture of the caller's response to the prompt, the recognition of the caller's response using a speech recognition engine, and a database access to support the caller's request. When a speech recognition event is logged, for example, the event record could include data, such as the grammar associated with the recognition request, the recorded utterance to be translated, a text translation (in a computer usable format) returned from the speech server and a confidence score indicating the reliability of the translation.

A detailed description of a simple application segment is as follows. The user is prompted to speak an utterance: “would you like your account balance, or your cleared checks?” The utterance the user speaks in response to that prompt is taken as audio data which is sent to a voice recognition engine along with the recognition control parameters to manage noise rejection modes, the grammar usage, etc. The recognition engine returns a response (recognition positive, semantic tag=account balance) or returns an error (not recognized) or any number of other outcomes. Each of these possible responses would be a data element in the recognition response event to be logged. The next step in the application may have the system query a database to get the caller's account balance. All three of these steps: the prompt, the recognition, and the database query, may occur on different parts of the overall system. All three of these events need to be logged, typically by the subsystem that executed the specific function. However, the logged events need to have enough information included in each log event to allow them to all be re-associated with the specific caller and application instance that generated them. Thus, logging is essentially the capturing of events, together with each event's associated data, such that captured data at a later time can be associated with various components of the application. The logging data can be used at a later point to determine if a certain recognition event occurred, and, if so, who was on the phone call and what were they doing in this application when a certain event (such as an error) occurred. Thus the logging data must capture more than just the event itself.

In many cases, the various subsystems that generate log events are manufactured by different companies, so the logging data from each component may be in different formats. A particular application process may require several different system components to be involved for proper execution, each generating their own log events. Since these events are logged in the various log formats of the different components, it may be difficult to track all the events that would show the complete progress of a specific application instance and user as they interact with the various system components.

For example, as discussed above, a typical event would be for a browser to send audio data to a speech server for translation into a text or semantic equivalent (a recognition event). Such an event is not always logged, and even if it is, the logs don't contain enough detail to identify the specific application instance or user generating the events. In the example, the prompt event from the browser will be followed by a recognition event on the speech server, and then a database access. However, there may be no mechanism in the logged data from the database, browser and speech server to allow the three events to be associated to the specific application instance and user. This prevents the tracking of an individual call flow through the various system components, and limits the utility of the subsequent reports.

In addition to logging commands that pass from device to device it is necessary to also log the audio spoken by the user in response to a prompt and to be able to associate that audio file with the recognition event that analyzed the utterance, and with the commands and status that were sent pertaining to this particular audio file. In order to accomplish this in a system it would be necessary to have multiple vendors working together, or for a single vendor to have anticipated all of the general use cases that would be required.

Compounding the problem is the fact that standards have emerged to specify the command response interface between what is generally referred to as a voice browser, and what is generally referred to as the speech recognition server. These two components communicate with each other over a communication link using a common protocol called Media Resource Control Protocol (MRCP). Thus, it is not possible to simply add information to commands (or data) so it can be logged in the event record, if any such added information is outside the protocol, since it will cause errors in the system.

In some situations it is helpful for the media data (voice, video, etc.) passing from a user to an interpreter (such as a speech server) to be rendered into a more tangible medium. That more tangible medium could be, for example, written text, or it could simply be that the media obtained from the user is burned into a CD, DVD, or other storage format. Today, when a voice browser is used for translating an utterance into a corresponding system usable format the translated utterance is used for control purposes but not otherwise available for presentations to the user, except in some situations the response is repeated to the user to be sure the utterance was interpreted correctly.

### BRIEF SUMMARY OF THE INVENTION

The present invention is directed to a system and method in which an interface (proxy) is positioned between a browser and a speech server such that the proxy, while transparent to both the browser and the speech server, collects and stores data, including utterances and other media obtained from a user, such that the media data can be retrieved in a uniform manner for subsequent manipulation, such as, for example, transcription or presentation (or preservation) of a tangible format of the media as a function of a transaction session with the user. The proxy is a passive monitoring device positioned between the functioning components of a system such that the proxy looks to the browser as a speech server and looks to the speech server as a browser. In one embodiment, information (such as, for example, session ID information) pertaining to the operation of applications running on the application server is embedded by the application into the VXML (or any other command and control protocol) script passed to the browser. The information is embedded in such a way that the control script will ignore it, and pass that information on to the speech server unaltered. This extra information can be a correlation ID, and the proxy strips this added information from the commands for logging purposes along with associated commands, events or command results so that the log will track the progress of the application. In one embodiment, the proxy facilitates the removal of correlation information in the data passing between the browser and the speech server. In another embodiment, the proxy serves to extract (or add) information passing between the browser and the server without modifying the data stream, and to send the extracted information to (or receive information from) remote systems. In all cases the proxy will make sure that the data going to the speech server and browser conform to the specifications of the MRCP protocol, or to any other protocols that may emerge that performs the function of standardizing the communication between a controlling script and a speech server.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an overview of a prior art IVR system;

FIG. 2 is an overview of one embodiment of a communication system using a proxy interface for enhancing the collection of logging data;

FIG. 3 shows an embodiment of the invention as used for manual correction of recognition errors;

FIG. 4 shows an embodiment of the invention as used in conjunction with other system operations;

FIGS. 5, 6 and 7 show embodiments of methods of operation; and

FIG. 8 shows a portion of a VXML document giving an example of how correlation IDs could be embedded in the communication between the browser and the speech server.

### DETAILED DESCRIPTION OF THE INVENTION

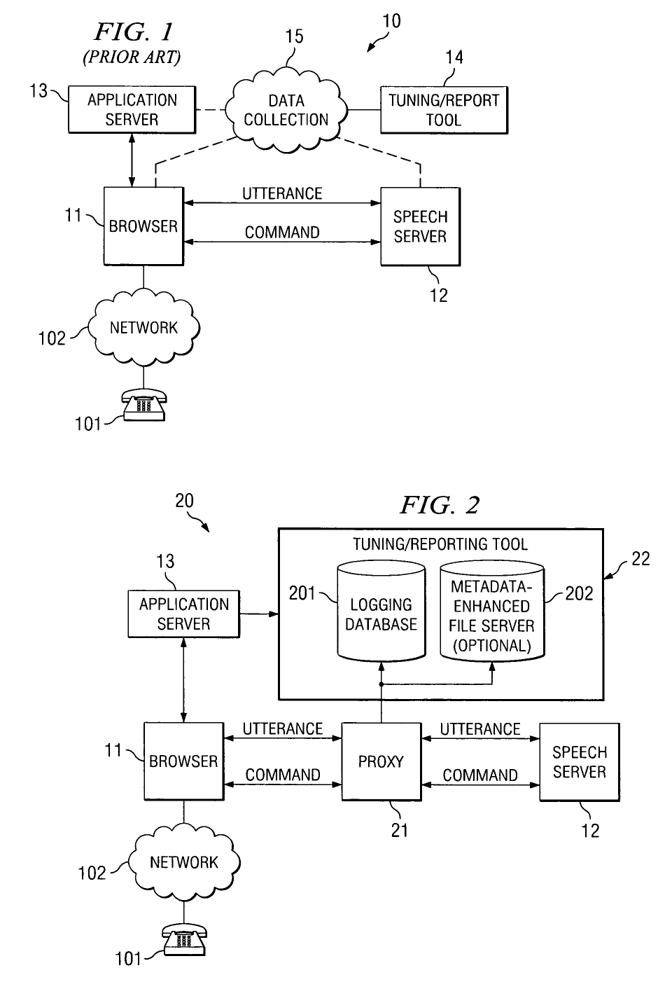

FIG. 1 is an overview of a prior art IVR system using a VoiceXML (VXML) browser. Application server 13 is typically responsible for the logic controlling the top level of the application. Server 13 provides a script to the browser. The script is a collection of mark-up statements (or process steps) that are provided to the browser in response to requests from the browser. This script could be, for example, a series of audio prompts, and voice (or DTMF) recognition requests. Assuming a voice recognition request, the voice recognition will be performed by speech server 12 in response to a request from the browser, which, in turn, operates from the script provided from the application server. Note that while the VXML protocol is discussed herein, any protocol, such as Speech Application Language Tags (SALT), mark-ups, api access, etc., can be used.

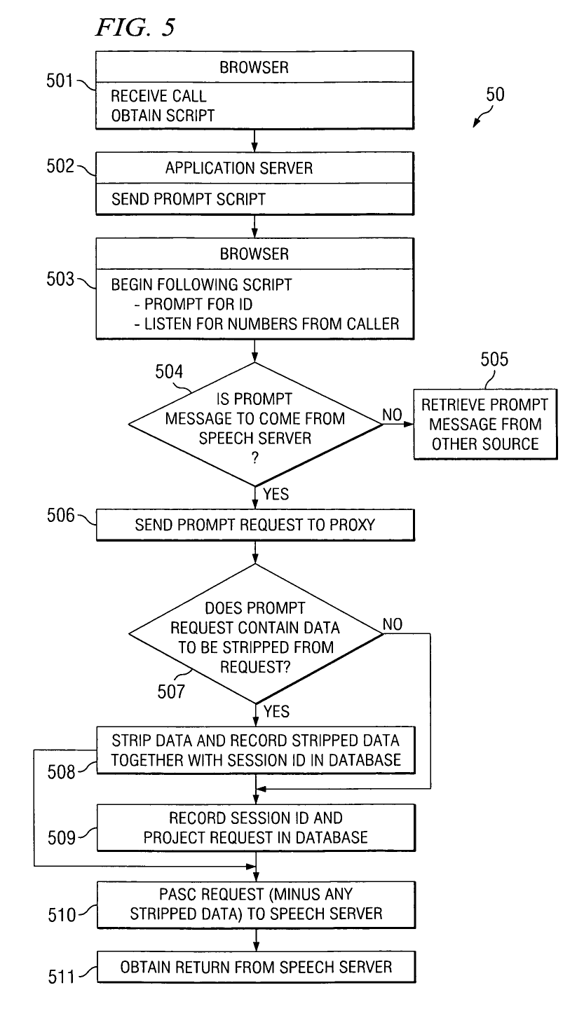

There is currently a standard protocol called Media Resource Control Protocol (MRCP) that describes the command and control as well as the response protocol between the VXML browser and the speech server. For discussion purposes herein, the protocol used will be assumed to be the MRCP protocol. However, the concepts discussed herein are not limited to the MRCP protocol but can be used with any protocol used for passing information back and forth between a browser and a speech server. Note that speech server 12 does not directly communicate with application server 13. Browser 11 is always in the middle, taking commands (in the form of scripts or process steps) from the application server, (or from any other location) and using those commands to orchestrate detailed tasks (such as recognition events) using the MRCP protocol to invoke the speech server. The challenge with this, as discussed above, is that data is typically required for both tuning and report generation from all three domains; namely, the application domain, the browser domain and the speech server domain. The application domain is shown as a dotted line in FIG. 4. The challenge being that data collection is typically across three vendors, each vendor having its own logging infrastructure. Currently this data is collected in a variety of ways (some being hand entered), all of these various collection methods being depicted by data collection cloud 15, FIG. 1. The collected data is then stored in tuning/report tool 14, as shown in FIG. 1.

Note that in the embodiment shown there are two bi-directional communication paths between the browser and the speech server. One path is the path used for command and control data. This path typically would use the MRCP protocol. The second path is a media path which in the example discussed is a voice path. This path is labeled “utterance”. The voice path typically uses the RTP protocol. Both paths can be bi-directional, however the RTP (utterance) path is typically one way at a time: browser to server for recognition and server to browser for text to speech. The MRCP path would contain data control segments while the speech path would typically contain utterances. Also note that while a speech server is shown and described, the functions performed by the speech server could be expanded to include any media recognition and thus the term speech server herein can include any media recognition application. Also note that the MRCP protocol discussed herein is an example only and any protocol will work with appropriate changes to how “extra” data is removed or ignored by the speech server.

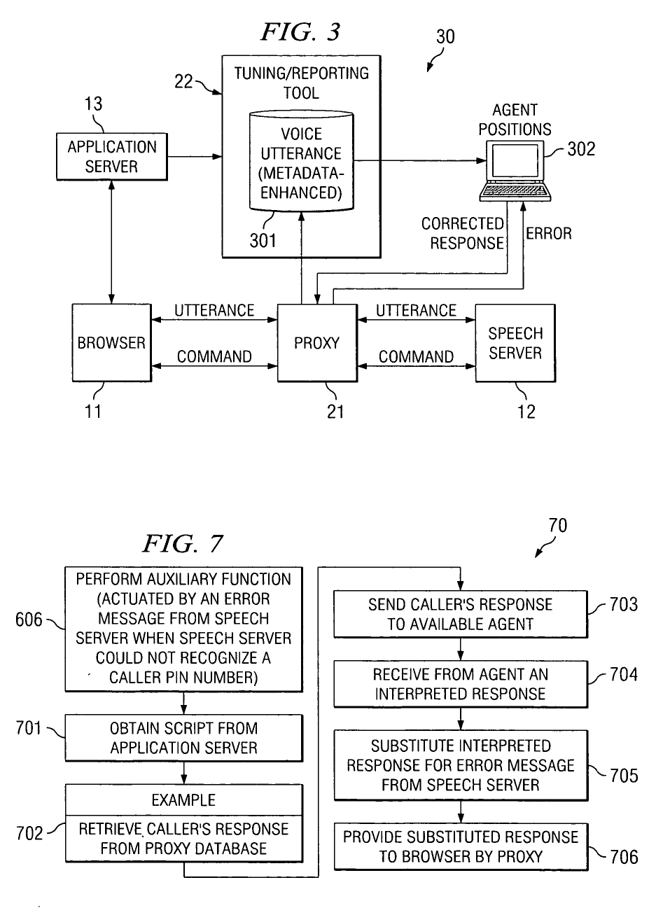

FIG. 2 is an overview of one embodiment of a communication system, such as system 20, using proxy 21 as an interface for the centralization of data collection. In the embodiment shown, browser 11 speaks to proxy 21 sitting between the browser and the speech server. To browser 11, the proxy interface appears to be a speech server, and to speech server 12, the proxy interface appears to be a browser. Using this configuration, the proxy can passively monitor the command and control protocols going between the browser and speech server and also monitor the audio path going from the browser to the speech server for the recognition event. The proxy can then record (log) both voice and control data into a common database. This then yields a vendor neutral implementation for collecting logging data. Using this system, it is not necessary to do invasive logging in the browser or in the speech server. At the same time, it is possible to coordinate the logging information with the generated presentation layer from the application server by controlling what goes into the mark-up language for the recognition events, such as, for example, the session ID.

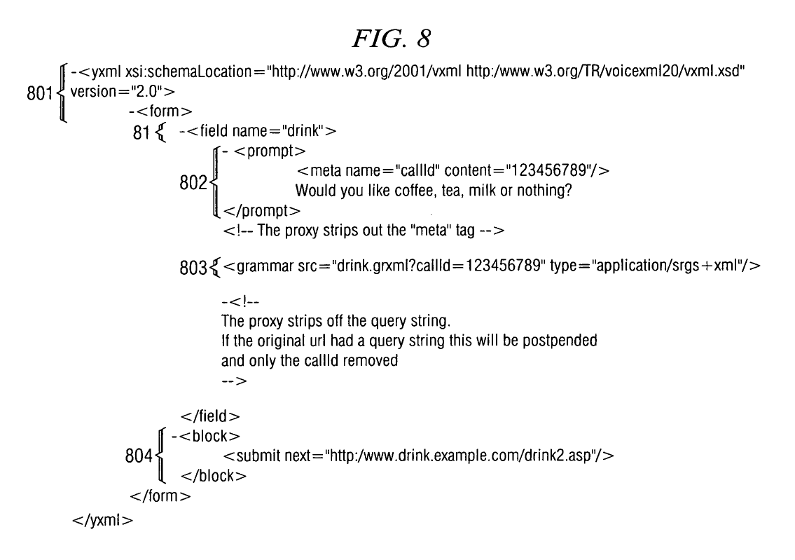

Adding a correlation or session ID to logging data is important since the MRCP protocol doesn't coordinate a particular MRCP protocol session with an application session. That problem has been overcome by embedding within the mark-up language additional information about the session that the browser passes through (so it believes) to the speech server. In some embodiments, the proxy will strip the added data from the protocol. In other embodiments, as discussed with respect to FIG. 8, the added data can be passed through to the speech server.

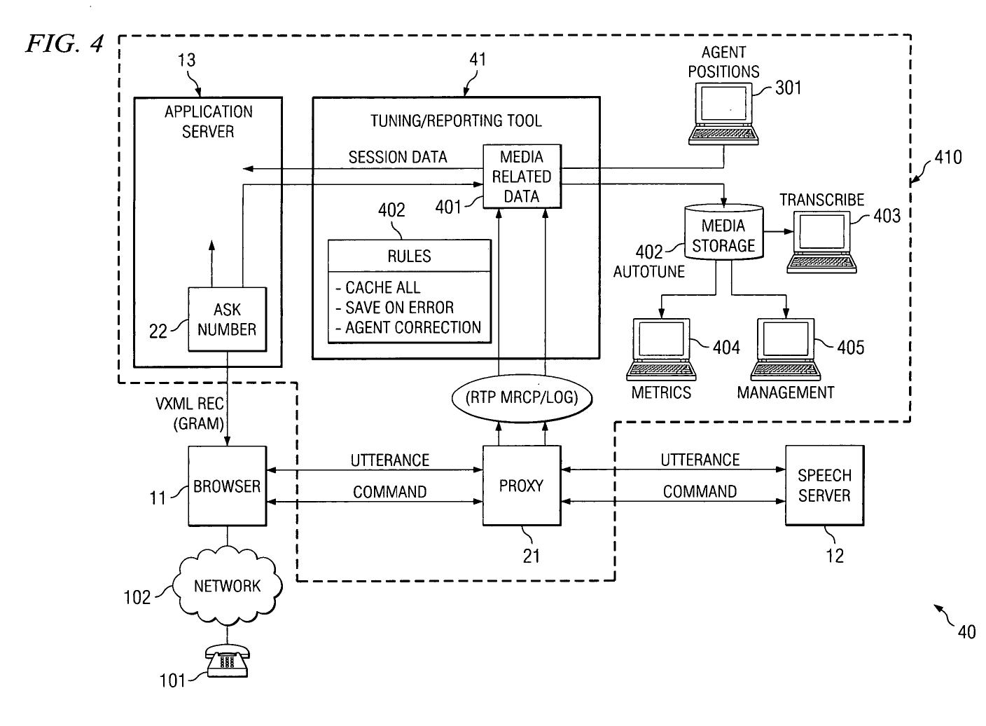

FIG. 8 shows a VXML document with one embodiment of a “Meta” tag (Section 801 see http://www.w3.org/TR/2004/REC-speech-synthesis-20040907/#S3.1.5 and http://www.w3.org/TR/speech-grammar/#S4.11) to pass information through the browser to the speech server. In this case, the proxy does not necessarily need to strip the meta information from the MRCP protocol since the speech server will ignore the meta information, as long as it doesn't recognize the specific key in the metadata key/value pair. The proxy can monitor the MRCP channel and spot the added information (in this case the session ID) in the MRCP protocol stream, then parse and read the metatag data, as well as the other data pertinent for logging, and send the compiled data to storage in an event record in the logging database 201 of tuning/reporting tool 22 along with the command and other associated data. As will be discussed, metadata can also be added, for example, to the audio portions of the logged data. This metadata tagged information can be stored in a separate location, such as file server 202. This file server can be used, for example, as a voice utterance file storage system, as discussed with respect to FIG. 3.

In part 802 of the VXML script, FIG. 8, a meta name “CallID” along with the meta name data 123456789 is placed in the VXML script. When the browser executes this script, the browser is requested to play a prompt “Would you like . . . ”. The metaname and data are passed with the prompt request across the MRCP protocol channel to the speech server for processing. The speech server will play the prompt, and ignore the metadata, as it does not recognize the key name. As the prompt play request is passed across the MRCP interface, the proxy detects the play command and the associated “CallID” metatag. The proxy attaches the Call ID to the prompt event along with other metadata associated with the prompt and sends that data as an event record to the log database.

A grammar is a collection of utterances that the user may say in response to a particular prompt. The grammar is passed across the MRCP interface from the browser to the speech server either directly (called an inline grammar) or by passing a reference to the grammar. In the case of an inline grammar, the correlation ID can be added as metadata into the grammar in the same manner described above. For an indirect reference this is impractical since the grammar exists in an external location and may not be modifiable. In this case the system appends extra information (i.e., the session ID) to the grammar as a query string added to the grammar identifier (URL). So within the grammar field there is appended extra information to tell the logging system which application instance on the application server the data or command is associated with. The proxy will, if necessary, optionally remove this extra query string so the speech server will see the original grammar name.

FIG. 8 shows one example of a VXML script (Section 801) which in turn creates a metatag correlation ID (Section 802), in this case called a “Call ID” or “ref ID” with the value 123456789, that is passed with the prompt command in the MRCP protocol. The proxy attaches the Call ID to the prompt event and sends the call ID to the log database (Section 803). The TTS engine in the speech server ignores the Call ID metadata (Section 804) as it does not recognize the metadata key type. Section 802 deals with a TTS resource in the speech server defining how the resource will play a prompt while Section 803 deals with a speech recognition resource in the speech server. Section 802 defines how the resource will recognize a user utterance that is responding to the prompt.

Segments 802 and 803 (which, as discussed above, are control segments for MRCP path and associated utterances or voice segments for the RTP path) are contained within a <field> tag, which causes a specific sequence of events to occur. Within a field tag, all <prompt> commands are aggregated, and played sequentially. However, before the prompts are played, any grammars defined in the <field> tag are loaded into the previously-allocated recognition resource, and the speech recognition resource is activated, so it begins monitoring the user's spoken audio channel. The recognition process is typically started jut before any prompts are played, in case the user wants to “barge-in” with the answer to a prompt before the prompt is played, or completed playing.

So, even though the grammar loading code 803 is after the prompt definition code 802 in the example, the fact that they are all within the <field> tag causes the grammar to be loaded and recognition started before the prompts are played. (There are exceptions to this scheme if a “no-barge-in” option is selected. For ease of discussion, these will be ignored in this example).

The actual sequence of events is as follows: There is a recognition allocation command (not shown), followed by a grammar load, where the grammar data is described with code Section 803, followed by a prompt play where the prompt information is described by code Section 802, followed by a user utterance, followed by a recognition results.

Code section 804 passes the information returned from the speech server to the appropriate server, and steps the application to the next VXML page.

Turning now to the process of passing correlation IDs from the application server to the proxy, without confusing the speech server or causing the speech server to generate errors. In code Section 802, a TTS resource is asked to generate the spoken utterance “Would you like coffee, tea, milk, or nothing?” In order to correlate this prompt generation and play event with a specific application instance, a correlation ID, in this case shown as meta name “CallID” with value “123456789” is inserted within the <Prompt> tag.

According to the MRCP (and/or the SSML) specification, unrecognized meta name information should be ignored in a TTS server. So, when this segment of code is executed and the command to play the prompt is passed to the TTS engine, the meta name data is passed with the other data in the TTS prompt command over the MRCP protocol to the speech server. The proxy only needs to capture the meta name value “123456789” as it is sent on the MRCP channel and passed through the proxy to the speech server. The proxy does not need to strip the meta name information from the <prompt> command as it goes to the speech server, as the speech server should ignore the extra information. In situations where the speech server does not ignore the extra information, the proxy will strip that data from the protocol. This stripping can be accomplished, for example, by placing certain codes (such as a double star) ahead of the added information, or by using a standard name for the meta key name (such as “CallID” or “MRCP Proxy ID”.

The proxy can then proceed to log the prompt play event in the logging database along with the correlation ID that was discovered in the meta name data. Since the proxy can also see the audio stream coming from the speech server TTS engine to the browser, the proxy can also capture a copy of the audio prompt being played, and send that copy to the specialized metadata-enhanced file server, where the correlation ID, as well as other metadata about the audio file can be embedded in the audio file for later reference.

In code segment 803, the grammar required for a speech recognition resource is loaded into the speech server. There is no simple way to put a metadata tag inside a grammar to be passed to the proxy and speech server. While metatags can be embedded in grammars, the internal structure of many commonly-used grammars are not accessible to the application developer. Therefore correlation IDs and other logging-centric data can not easily be embedded in the grammar itself. To solve this problem, the correlation ID is placed as an extension of the grammar name, (the ‘src=’ parameter) which is under control of the application.

In the example, the actual grammar name is “drink.grxml”, which is essentially the address where the grammar resides. The application tool has added some additional information, namely the string “?callid=123456789” to the grammar name. However, if this modified grammar address was passed to the speech server it would give an error, as the speech server would be confused by the additional non-address information in what was supposed to be a grammar address.

In general, the additional information added to the address should be ignored by the server (assuming a typical, lax analysis of URL parameters). When it is not true, the proxy will strip the additional information. Stripping may also be desirable so that a single grammar is not treated as unique by a caching algorithm in the speech server.

Most interactive dialog systems break their dialogs down into sets of dialog “turns”. In each dialog turn, the system asks a question (prompt) and the user responds, and the system decides what to do next depending on the user's response. This is repeated until the user completes all of the tasks they wanted to attempt.

From a logging perspective the following occurs:

1. Somewhere at the beginning of the application, a speech recognition resource is allocated (not shown in FIG. 8). As part of this allocation, an MRCP channel is allocated for speech recognition commands, responses, and audio streams. The proxy can see this allocation and more specifically the allocated channel number, which will be critical in subsequent steps for correlating various events.

2. In the next step, the browser loads the VXML (or other protocol) document described in FIG. 8, and parses the VXML script.

3. <Field> tag 81 in the script tells the browser that it must perform a prompt/recognize dialog “turn” so the browser proceeds to parse the contents of the <field> tag. A dialog turn consists of a prompt, a grammar load, a recognition event, a return of the recognition results, and the selection of the next dialog turn. All of these events except the selection of the next step, happen within the field tag. In FIG. 8, the field tag code starts with <field name=“drink”> (first line of section 81), and ends with </field> just above section 804. The script between these two tags (a start tag and an end tag) execute the dialog turn. Note that the dialog turn events do not necessarily happen in the order they are listed in the field tag. The actual order of execution is that the grammar is loaded at (section 803) and the prompt is played at (section 802). Note that the user response is not shown in FIG. 8. Also not shown is that the speech recognition engine recognizes speech and returns the result, which is sent to the application to decide what to do next (section 804).

4. The grammar tag tells the browser what grammar is to be used by the speech server, so the browser sends the “load grammar” command with the name and address of the grammar to the speech server, so the speech server can find the specific grammar required, and load it. The proxy would like to log the “load grammar” command in the logging database to keep track of what grammars were used, at what time. However, the application server has attached extra correlation ID data to the grammar name, to help the proxy log extra information in the log database so this event can be tied back to a specific application instance, and specific user. The extra data on the grammar name will confuse the speech server, so the proxy must strip the correlation ID data from the grammar name before passing the grammar load command on to the speech server.

5. Once the grammar has been loaded, the recognition should start. In situations where there is a specific command sent from the browser to the speech server to start recognition, the proxy will log the “start recognition” event with the same correlation ID as the grammar load command. Even if the actual correlation ID cannot be placed in the recognition command, the fact that the “start recognition” command occurs on the same MRCP channel as the grammar load command ties the two events together, so the proxy (or the logging database) can add the same correlation ID to the recognition start, just like the grammar load event did. The audio stream containing the user's response to the prompt passes from the browser to the speech server while the user is answering the prompt. The proxy can capture this audio data and send it, along with the appropriate metadata, to the metadata-enhanced file server. Since the audio data and recognition commands both come in the same MRCP channel between the browser and the speech server, the proxy can correlate the audio data with the correlation ID sent in the grammar load command.

6. Once the recognition starts, the prompt will begin playing. However, the prompt play commands may go out on a different MRCP channel from the channel used for the recognition commands, since the prompt commands go to the TTS engine in the speech server, and the recognition commands go to the recognition engine in the speech server. Therefore, the system can not use the channel number to correlate the TTS prompt events to the recognition events, even though both processes are originated from the same application instance. So in this case the meta name tag is placed in the <prompt> tag, and that meta name data is passed in the MRCP protocol through the proxy and to the speech server. The speech server should ignore the unrecognized meta name. The proxy can see the meta name tag as it watches the MRCP protocol stream between the browser and speech server, and include the correlation ID with the other <prompt> event information that gets logged to the log database.

7. When the user has finished speaking, the recognition results come back over the MRCP protocol to the browser. The proxy can identify what correlation ID is associated with the recognition results by looking at the MRCP channel that the result data was sent on. The result data will always return on the same MRCP channel as the grammar load and recognition start commands were sent on. In this way the control segments in the MRCP protocol can be “keyed” to the utterances on the RTP (media) channel.

The proxy inspects each command coming from the browser in order to find any correlation IDs put there by the application. The proxy removes these correlation IDs and passes the commands on to the speech server. The proxy also taps into the command responses from the speech server, so those responses can be logged. The proxy associates the correlation IDs passed in the original command to the responses from the speech server, so that the command and its response can both be logged with the correlation ID. In one embodiment, a processor in the proxy (not shown) is programmed to perform the stripping and passing functions.

The proxy also taps into the audio to and from the speech server, sending the audio to the logging system (and to other entities, such as to the live agent transcription system) for further use. Again, the proxy tags the audio with the correlation IDs and other metadata about that audio before sending it to the logging system. This facilitates the usage of the audio data for reporting, transcription, tuning, and many other uses.

FIG. 3 shows one embodiment 30 of the invention as used for speech recognition error correction. In one example, audio is fed to the speech server from the browser so that the speech server can recognize the speech. The response from the server is “the word is . . . ”. Another response can be, “No-match. Word not recognized”. The proxy can be set up to recognize the “no-match” message (or a low accuracy probability of a matched word or phrase) or any other signal. It such a “no-match” or “low confidence” condition occurs, instead of passing the error message to the browser, the proxy can gather all of the data that was associated with the utterance including the recorded audio, and send it all to an available agent, such as agent 301. The agent can then listen to the utterance and send the corrected answer to the proxy to send to the browser. The net result from the browser's point of view is that it received a correct response. The browser does not know that there were errors generated in the automated voice recognition step or that (in some situations) data may have been added by a process other than the speech server. This allows real-time correction of speech server errors without requiring support from the original application running on the application server.

In some situations this delay in providing a response could trigger a time-out fault in the browser, but that could be overcome in a variety of ways, such as by having the proxy send back a “wait” message telling the browser that there will be a delay.

Note that the application server script in the browser didn't change and, in fact, didn't know that an error might have been corrected manually. This, then, allows a third party application script to assess a fourth party browser and run the applications on fifth party speech servers and still achieve proper logging and reporting features. In addition, this arrangement provides a non-invasive way of improving application performance by adding the proxy.

FIG. 4 shows one embodiment 40 of the invention as used in conjunction with other operations. Using media hub 402 the system can integrate asynchronous improvements into the system. Thus, by using, for example, metadata embedding in the stored data (for example, as shown in co-pending U.S. patent application Ser. No. ______ , [Attorney Docket No. 47524-P137US-10501428 entitled “SYSTEM AND METHOD FOR MANAGING FILES ON A FILE SERVER USING EMBEDDED METADATA AND A SEARCH ENGINE”; Ser. No. ______ , [Attorney Docket No. 47524-P138US-10501429] entitled “SYSTEM AND METHOD FOR RETRIEVING FILES FROM A FILE SERVER USING FILE ATTRIBUTES”; and Ser. No. ______ [Attorney Docket No. 47524-P139US-10503962] entitled “SYSTEMS AND METHOD FOR DEFINING AND INSERTING METADATA ATTRIBUTES IN FILES”, all filed concurrently herewith, and all owned by a common assignee, which Applications are all hereby incorporated by reference herein), there are a number of features that could be provided in the IVR system. One such feature is a transcription service, as shown by processor 403. In such a service, an agent (live or otherwise) can listen to the audio and type the text transcription of the audio. The application could then embed the transcribed text into the audio file using the metadata embedding methods described in the above-identified U.S. patent application Ser. No. ______ , [Attorney Docket No. 47524-P137US-10501428 entitled “SYSTEM AND METHOD FOR MANAGING FILES ON A FILE SERVER USING EMBEDDED METADATA AND A SEARCH ENGINE”. The file could be stored in a file server such as described in the above-identified U.S. patent application Ser. No. ______ , [Attorney Docket No. 47524-P137US-10501428 entitled “SYSTEM AND METHOD FOR MANAGING FILES ON A FILE SERVER USING EMBEDDED METADATA AND A SEARCH ENGINE”. From then on, any time the file is accessed, the transcription of the audio data would be available by simply extracting the transcription text from the metadata embedded in the audio file. Any specific audio file for a particular user (on a session by session basis or otherwise) and application instance could be accessed because, as discussed above, each audio file (utterance) will have the session ID along with other metadata pertinent to that audio file embedded in the audio file. The metadata-embedded audio files can then be stored in an enhanced file server which would index the metadata embedded in each file to allow for future retrievals. In such a situation, the audio files with their associated metadata would be stored in the file server, and the command and response events would be logged into the logging database. If the system administrator or other application wanted to access the audio response of a particular user to a particular prompt, the administrator (or application) would go to the logging database, find the session for the user, find the specific prompt-response events that were logged for that part of the application, and get the correlation IDs for that portion of the application. Then the administrator would go to the specialized file server that held the audio files with the embedded metadata, and request the specific audio files using the correlation IDs in the log.

Note that with respect to transcription this could be any transformation of the stored data from one format to another. For example, speech could be rendered in text format, or graphics could be interpreted for human understanding, all by transcription applications running, for example, on processor 403. Also note that the transcribed (transformed) stored data can then be stored, for example in media storage 402, for session by session access under control of the associated session ID information captured by the proxy. If desired, the system could also store the transcribed data onto CDs, DVDs or other portable storage formats in the well-known manner with each such portable storage medium, if desired, being a separate session.

The files placed on the metadata-enhanced file server can contain other types of metadata useful for various applications. For example, pre-recorded prompts in an IVR system today typically have a fixed set of responses that are expected from the user when that prompt is played. These expected responses are called “grammars” and every prompt will usually have a set of these grammars associated with it. It would be straightforward to place the grammars associated with a prompt with the other metadata embedded in that audio prompt. This scheme facilitates the grammar tuning process.

As a user responds to a prompt, it sometimes happens that the user's response is not included in the expected set of responses (grammars) associated with that prompt. This will result in a “no-match” result (as discussed above) from the speech server. A major part of the tuning process is focused on identifying these missing user utterances, and updating the grammars with these new responses, if the responses occur often enough. By embedding the grammars in the pre-recorded prompts metadata, embedding the transcriptions of the user responses in the user response audio recordings, and storing all of these audio files on the metadata-enhanced file server, as discussed in the above-identified application, above-identified U.S. patent application Ser. No. ______ , [Attorney Docket No. 47524-P137US-10501428 entitled “SYSTEM AND METHOD FOR MANAGING FILES ON A FILE SERVER USING EMBEDDED METADATA AND A SEARCH ENGINE”, a tuning process can be designed to examine this metadata and make decisions about modifying the prompt-associated grammars to improve recognition rates (semantic categorization rates) in the speech server.

This tuning process can all be controlled by rules engine 402. The system can derive metrics, as shown by processor 404, regarding performance of a particular grammar, or a particular recognition type of event, etc. This then will allow a user the ability to manage a prompt function and its associated input data as an entity on the system and actually monitor and improve on that, even though that particular prompt function can be used in multiple applications. This is so, since the system has captured the details of each particular transaction and stored the transaction as a whole, with a portion in the specialized file server (if desired) and a portion in the logging database.

For example, if the system tunes the grammars in a wake-up call application, that “fix” will also apply to all other applications which use the same prompt-grammar pair. Thus the prompts are being improved independently of how they are used in individual applications. Accordingly, improvements that are made, for instance, in a travel application are automatically available to improve the wake-up call application, assuming those two applications share common functions. The improvements rely on the gathering and processing of metrics, for example, by metrics processor 404 used, if derived, in conjunction with management processor 405. Autotune is another example of a feature that could benefit by having all the session information self-contained and available.

By way of a specific example, assume an “ask number” application (element 22) in application server 13. This application prompts a user using phone 101 and network 102 to input a number, such as a PIN number. In the logic script, there are typically commands, such as, “play a message”; “do a recognition event for a particular string of numbers;” “recognize those numbers;” and “hand them back.” In this example, the “ask for number” prompt generates a VXML request that plays a prompt from the speech server. The “recognition” uses a particular numeric entry grammar. Media server 401 receives that grammar because it was monitored from the protocol between the browser and the speech server. The session ID was also monitored from the browser/speech server communication link and this ID is also now stored in the application environment, i.e., in server 401.

As shown in FIG. 4, rules engine 402 can be programmed to cause proxy 21 to behave in different ways. For example, the information can all be cached and then saved only on a detected error. Or all the data can be cached and all of it saved. Thus, the ability to manage proxy 21 allows for the management of many different features, either on a user-by-user basis or from time to time with a certain user. Note that rules engine 402 can be part of tool 41 or it could be stand alone or a part of any other device provided it has communication with proxy 21.

In the embodiment shown the proxy is an extension of the application server environment as shown within the broken line. The media storage, the proxy, the media related data, the rules, can all be in the application server domain if desired. The elements that are outside of the application domain are speech server 12 and browser 11. Note that in this context an environment is a set of processes, not necessarily physical pieces of hardware. The proxy could be implemented as a separate physical device or part of a server housing the application or other elements of the system.

Note also that only a single browser and a single speech server have been shown but any number of each could be used without departing from the concepts taught herein. The proxy can be used as a router to an available speech server and can thereby provide load balancing. Not only can the proxy provide load balancing, but it can look at the health and performance of individual speech servers and allocate or de-allocate resources based on performance. The proxy or the tuning application could look at historical performance of grammars, for instance, since the system now knows enough to correlate all the elements together. This then allows a user to create applications for changing speech servers based on a particular grammar or set of grammars, or on grammar size, etc. The system could also look at histories and realize that some servers are better at certain grammars or certain combinations and direct certain traffic to the servers that have shown statistically to be better for that application.

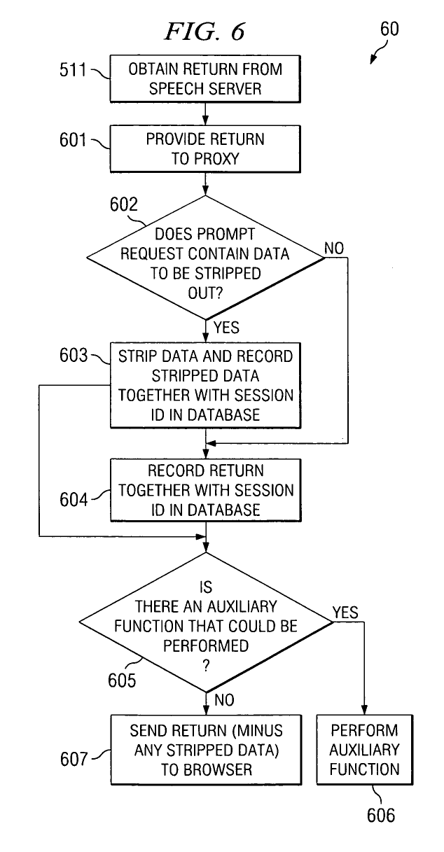

FIG. 5 shows one embodiment 50 of a method for passing information from a browser to a speech server and for recording data on a command by command basis by the logging proxy, which is interposed between the browser and the speech server. As discussed above, it is important to keep the browser unaware of the information added to the protocol so as to sneak that information through the browser on its way to the speech server as discussed above with respect to FIG. 8. In addition, the added information should be structured to not affect the operation of speech server 12, or the added information must be removed by the proxy before reaching the speech server.

In process 501, a call comes into the browser. The browser wakes up because of the call and requests a script from the application server. The script will contain several instructions, such as “play this prompt using TTS” or audio, load a grammar, recognize a user utterance, and “do this” or “do that.” In process 502, the script comes from the application server to the browser and in process 503 the browser begins following the script. As discussed, this is a specialized script having extra pieces of data stuck in it in ways that are ignored by the browser. However, if these “extra” pieces of data (for example, the session ID) actually go to the speech server, they may cause errors in the speech server since the extra data bits may be outside of the expected protocol. In such a situation, the speech server would return errors. One function of the proxy, as has been discussed, is to remove these “extra” bits of information when need be.

Processes 504 and 505 optionally check to see if the browser is to use the speech server and if not then the browser sends messages to other locations (discussed with respect to FIG. 7). If the browser is to use the speech server then the prompt with the “extra” bits of data is sent to the speech server, via process 506. However, the proxy which is interposed in the communication link between the browser and the speech server, intercepts the message.

Process 507 (optionally) determines if “extra” data is included in the message, and if it needs to be removed before forwarding the data on to the speech server. If the data needs to be removed, process 508 strips the extra data from the message and saves it, for example, in database 201 (FIG. 1). Process 509 stores all of the snooped data whether or not extra data is included.

Process 510 then passes the stripped data to the speech server and the speech server operates on this data in the well-known manner since it now conforms to the standard protocol.

In one embodiment, the “extra” data is added at the end of the string of text associated with a <prompt> tag where there are markers to identify the correlation IDs embedded in the TTS text. If this extra data were passed on to the speech server it would cause the TTS engine problems trying to speak the correlation ID data and markers in the text it is supposed to render into audio. The proxy must strip these markers and IDs before passing the data on to the speech server. Since the system (via the proxy) has now captured the correlation ID, the system can then tie the ID of a particular event to a particular person and application instance. Otherwise this event (for example, a TTS prompt play, or translated PIN number) would come out of the speech server and the system would have no idea who's PIN number it is or what data was given to the speech server for this particular translation. Thus, using the proxy the system can then log an event that says, “John's application, banking application” requested it. Not just some banking application, but John's banking application actually requested this play prompt event.

Process 511 obtains the recognition results from the speech server in the well-known manner. As shown in FIG. 6, this return is sent to the proxy from the speech server. Optionally, the speech server could add “extra” data (if it was designed to do so) and if this extra data were to be added then processes 602 and 603 would strip out this extra data while process 604 records the snooped data from the speech server. The stripped data goes back to the browser and the browser plays the next portion of the script to the user. The user then hears, for example, the browser say “give me your PIN number.”

Processes 605 and 606 control the situation (optionally) when an error (or another need for intervention) occurs. In this situation the logged data pertaining to the current event is sent to an auxiliary location, such as, for example, to an agent, for resolution of the problem based on the logged data from the logging database. This operation will be discussed in more detail with respect to FIG. 7. Process 607 then sends the return from the speech server to the browser.

The discussion above is for a prompt and for a recognition event (asking the speech server to listen to the spoken PIN and tell the system what numbers were spoken or keyed in). These two types of events each requires a different scheme to get the extra data to the proxy. When the browser finishes delivering the prompt (“please say your PIN number”), the next step in the script is to have the speech server listen to the user's response. To accomplish this, a grammar must be sent to the speech server. This grammar is established based on what is expected from the user. Thus, the user is expected to say something that's a PIN number. As soon as the audio prompt to the user ends, or sometimes as soon as it starts, the browser sends a new command to the speech server, through the logging proxy that says “do a recognition.” This message is part of a script that came from the application server. The application server in that script, as discussed above, has hidden extra data pertaining to the fact that this is John's banking application (as shown in FIG. 8). This extra data has been placed in an addition to the grammar name. However, a recognition command is different from a text to speech command (the prompt) because the recognition command doesn't have text to hide the extra data in. The recognition command, however, does have a grammar which is a text string. The extra data is then appended to the grammar name/address description for these types of commands. This is possible because the browser does not check to see if a grammar name is correct. It just takes the grammar name from the script (from the application server) and passes the grammar (with the extra data appended) to the speech server. The proxy as discussed above, strips this extra data from the grammar. One aspect of the proxy system is to be sure the browser can't recognize the added data but yet have the data fall within the VXML and MRCP standards.

FIG. 7 shows one embodiment 70 for performing an “auxiliary” function assuming an error (or for any other reason) as controlled by process 606 (FIG. 6). Process 701, in response to a signal from the proxy, obtains a script, for example, from application server 13 (FIG. 2). Thus, rather than the proxy returning an error message to the browser, the proxy intercepts the error and triggers the enabling of a script from the application server. The script can, for example, via process 702, take the audio which has been monitored by the proxy and send that audio to a selected agent (process 703) who has been selected by any one of a number of well-known methods. The agent then hears (or uses a screen pop to see) the audio that initially had been sent to the speech server for translation. The agent then types, or says, the translation to the audio (process 704) and returns the translation to the proxy which then (processes 705 and 706) sends the translated response to the browser. The proxy is doing more than just being a transparent proxy in this scenario. It is, unknown to the browser, running an application to an agent for help in performing a function. The browser believes that the return came from the server and not from the agent and acts accordingly. Note that the logging system can record the fact that there was an error and that the error was corrected by an agent, even though from the browser's (and user's) point of view no error was detected. However, the log (or a log report) will show a recognition coming in and an error coming out of the speech server and a corrected response from the agent (or from another system function).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for capturing data flowing among a plurality of individual components of an interactive voice response (IVR) system, said system comprising:
a proxy for interposing between a browser and a speech server; said proxy comprising:
a first interface for accepting communications from said browser, said communications sent from said browser in response to scripts, said communications containing both a control protocol and a voice stream, said control protocol understood by said speech server, said communications containing additional information not part of said protocol;
a second interface for delivering accepted ones of said communications to said speech server, and for accepting from said speech server communications for delivery to said browser, said communications from said speech server using a protocol understood by said browser; and
means for storing both said additional information and said accepted communications.

2. The system of claim 1 further comprising:
means for removing from said delivered ones of said communications said additional information not part of said protocol.

3. The method of claim 1 wherein said additional information is contained as part of metadata in said protocol.

4. The system of claim 1 wherein said additional information includes the identity of a particular transaction, said system further comprising:
means for using said stored data to resolve error situations within a particular transaction.

5. The system of claim 4 further comprising:
means for tuning said IVR based upon said stored communications, including both said control protocol and said voice stream.

6. The system of claim 1 further comprising:
means for changing the rules base of said proxy from time to time.

7. The system of claim 6 wherein one of said rules instructs said proxy to direct certain of said communications for alternate resolution, said alternate resolution selected from the list of autotuning, transcription, system management, metrics processing, media processing, selection of speech servers.

8. An IVR system comprising:
an application environment comprising;
at least one speech server for providing voice prompts to, and interpreting voice responses from, callers via a communication network;
a browser for interfacing said communication network with said speech server, said browser operating from instructions provided from said application environment, said instructions including a session identification for attachment to all communications between said browser and said speech server; said communication including both control and media data, said application environment further comprising:
a proxy for intercepting communications between said browser and said media server, said intercepted communications being stored in said database;
at least one database for storing said removed information and said intercepted communications in said database in association with a common session identification; and
at least one application for accepting from said database a stored record of a particular session and for performing a transformation of said session stored media data.

9. The IVR system of claim 8 wherein said proxy is further operable for removing from said communications information not part of a protocol used for control between said browser and said media server.

10. The IVR system of claim 8 wherein said session identification is contained in metadata in communications between said browser and said media server.

11. The IVR system of claim 8 wherein said proxy further comprises:
a process for intercepting certain communications from said media server and for substituting a modified communication for said intercepted communication.

12. The IVR system of claim 11 wherein said intercepted communication is an error message from said media server and wherein said modified communication is a correct response to a media server request.

13. The IVR of claim 11 wherein said correct response is generated during a single transaction between said browser and said media server.

14. The IVR system of claim 8 wherein said transformation is selected from the list of: speech to text transcription; storage on a storage medium individual to said particular transaction; interpretation of graphical images.

15. A method for collecting data in a voice response system, said method comprising:
adding session identification to each communication to and from a speech server;
capturing communications to and from said speech server; each captured communication including said removed added session identification; and
making any said captured communications available for additional processing on a session by session basis.

16. The method of claim 15 further comprising:
removing said added session identification on each said communication.

17. The method of claim 15 wherein said session identification is added as part of metadata on each said communication.

18. The method of claim 17 wherein said communication to and from said speech server is from a browser using the MRCP communication protocol and wherein said added session data is hidden within said protocol.

19. The method of claim 17 wherein said additional processing comprises:
performing system functions using said captured communications, said system functions selected from the list of: autotuning, transcription services, metric analysis, management functions, selection of speech servers, graphical interpretations, recording onto a portable medium.

20. The method of claim 19 further comprising:
incorporating metadata with said captured communications, said metadata used to enhance the performance of said system functions.

21. The method of claim 17 further comprising:
transcribing portions of said captured communications.

22. The method of claim 17 further comprising:
retrieving all said captured communications to and from said speech server for a selected set of session IDs;
translating said captured communications into a human recognizable format; and
recording said translated format in a storage media.

23. The method of claim 22 wherein said storage media is portable.

24. An IVR system comprising:
a browser;
a speech server;
a database; and
means for collecting attribute data from messages passing on a communication path between said browser and said server, said attribute data pertaining to commands, events and command results.

25. The IVR system of claim 24 further comprising:
means for stripping from said messages passing on said communication path any data added to said messages for session identification purposes.

26. The IVR system of claim 24 wherein any said added data is hidden from said speech server within and foreign to a protocol used for such communication path communications.

27. The method of logging data in an IVR system, said method comprising:
sending messages between a browser and a speech server, said messages pertaining to commands, events and data from said browser, from said speech server and from application programs running on either;
incorporating in said messages information relating to the session in which said commands, events and data belong;
extracting from sent ones of said messages said incorporated information;
storing said extracted messages together with said extracted session information; and
translating at least a portion of said stored extracted data on a session by session basis.

28. The method of claim 27 further comprising:
selecting one of a plurality of possible speech servers for each said sent message, said selecting based, at least in part, on said stored extracted messages.

29. The method of claim 27 further comprising:
invoking the assistance of a process other than said speech server process, said invoking being triggered by data contained in a message between said speech server and said browser, said invoking including translating data associated with a particular message.

30. The method of claim 27 further comprising:
invoking the assistance of a process other than said speech server process, said invoking being triggered by data contained in a group of messages between said speech server and said browser, said message group sharing a common session ID as contained in said stored extracted messages; said invoking including translating data associated with a particular message.
